(19) United States
(12) Patent Application Publication
(10) Pub. No.: US 2015/0192663 A1
(43) Pub. Date: Jul. 9, 2015

(54) HOUSING FOR LASER SITE SCANNING DEVICE

(71) Applicant: 3D Laser Mapping Ltd., Bingham (GB)

(72) Inventors: Graham Hunter, Bingham (GB); Richard Durrant, Bingham (GB); Rodney Jeakings, Northampton (GB)

(21) Appl. No.: 14/416,000

(22) PCT Filed: Jul. 19, 2013
(86) PCT No.: PCT/GB2013/051946

§ 371 Date: Jan. 20, 2015

(30) Foreign Application Priority Data
Jul. 20, 2012 (GB) 1212929.2

(51) Int. Cl. G01S 7/481; G01S 17/02; G01S 17/89

(52) U.S. Cl. CPC G01S 7/4813; G01S 17/89; G01S 17/02

(57) ABSTRACT

The invention relates to a housing for a site scanning device, as well as a computer program and method for operating the housing and a site scanning device. The housing comprises an aperture, an aperture cover having an open position and a closed position, an actuator configured to move the aperture cover between the open position and the closed position, and a controller configured to control the actuator and to interface with the site scanning device.

The present invention relates to the field of housings for site scanning devices. In particular, although not exclusively, the invention relates to a housing and a method of operating the housing and a site scanning device.

Site scanning devices, such as terrestrial laser scanning devices, have applications in sites such as quarries, railway sidings, mines or land fill locations, where they are used to monitor the effect of human activities and subsidence in those locations. For example, site scanning devices can be used to measure and monitor the stability of rock faces, landslips and man-made structures or used for ongoing, periodic measurements of volumes, stockpiles, cutbacks and waste dumps. Such devices can also perform geotechnical analysis of rock mass structure and behaviour.

Typically, such monitoring activities involve either leaving a site scanning device in-situ for an extended period, or repeatedly setting up equipment in a location, performing a measurement, and then removing the equipment. Disadvantages associated with the latter option are that such activities can be time consuming and inconvenient. A disadvantage with the former option is that the equipment is prone to total loss or damage from theft, adverse weather conditions or debris from industrial activities taking place at the site, such as blast mining.

A shed or but can be placed around the site scanning device to provide shelter. However, human interaction is still required to open a door of the shed when use of the site scanning device is required. Alternatively, if the site scanning device is positioned in a shed with a window, the window may easily be damaged by debris, become partially obscured by atmospheric dust and dirt or present an easy point of access for a thief.

An object of the invention is to address one or more of the above problems.

In accordance with a first aspect of the invention there is provided a housing for a site scanning device, the housing comprising:
an aperture;
an aperture cover having an open position and a closed position;
an actuator configured to move the aperture cover between the open position and the closed position; and
a controller configured to control the actuator and to interface with the site scanning device.

The housing can allow for more efficient operation of a site, as human intervention is not required to conduct a scan of the site. As the housing comprises the controller and an integrated actuator, the housing may be located in areas of a site that would otherwise be impracticable, such as on remote rock faces or in very high positions.

The controller does not necessarily have to be comprised within the housing. A separate controller unit outside of the housing may be considered to be comprised by the housing. That is, the controller may be separate, distal or remote, from one or more other components of the housing, such as a body of the housing. The housing may comprise the site scanning device disposed within the housing. The site scanning device may comprise the controller.

The controller may be configured to receive a signal from the site scanning device. The controller may be configured to control the actuator in response to the received signal. A signal received by the controller may comprise a command.

The controller may be configured to control the site scanning device.

The controller may be configured to transmit a signal to the site scanning device. The controller may be configured to transmit a signal to the site scanning device in order to control it. A signal transmitted by the controller may comprise a command.

The controller may be configured to synchronise timing of actuator operation and site scanning device operation.

The controller may be configured to command the actuator and the site scanning device automatically.

The controller may be configured to determine whether the aperture cover is in the open position.

The controller may be configured to command the site scanning device to initiate a scan if the aperture cover is in the open position. That is, the controller may command the site scanning device to initiate a scan only if the aperture cover is in the open position.

The controller may be configured to determine when the site scanning device has completed a scan. The controller may command the actuator to close the aperture cover. The controller may command the actuator to close the aperture cover when the scan is complete.

The controller may be configured to command the site scanning device to cease scanning. The controller may also be configured to command the actuator to close the aperture cover. The controller may close the aperture cover only once the scan is completed.

The housing may have a body. The body may comprise the aperture. A portion of the body that comprises the aperture may be obscured by the aperture cover when the aperture cover is in the closed position. That is, the aperture cover may be configured to obscure the aperture when the aperture cover is in the closed position.

The aperture cover may comprise a cylinder. The housing may comprise a cylindrical body. The body may comprise a cylinder. The aperture cover may comprise a prism. The housing may comprise a prismatic body. The body may comprise a prism.

The aperture cover and the body may have a sliding relationship. The sliding relationship may enable the aperture cover to move between the open position and the closed position.

The sliding relationship may be a rotational sliding relationship. The aperture cover and the body may have a common axis. The aperture cover may be configured to rotate about the common axis. Alternatively, the rotational sliding relationship may be provided by a hinge between the aperture cover and the body.

The sliding relationship may be a linear sliding relationship. The aperture cover and the body may have a telescopic relationship. The closed position may correspond to a position along a length of the body. The actuator may comprise a linear actuator.

The actuator may comprise one or more of a solenoid, a hydraulic or pneumatic piston, an electric motor or an internal combustion engine.

The aperture cover may comprise a seal configured to engage with the body when the aperture cover is in the closed position. The body may comprise a seal configured to engage with the aperture cover when the aperture cover is in the closed position. The provision of a seal between the aperture cover and the body can prevent the ingress of dust, debris or water inside the body of the housing.

The housing may comprise a locking mechanism. The locking mechanism may secure the aperture cover to the body in the closed and/or open position. The locking mechanism may be configured to engage when the actuator moves the aperture cover in to the closed position and/or open position. Any suitable locking mechanism could be employed, as will be apparent to the person of ordinary skill. The controller may be configured to command the locking mechanism to disengage before commanding the actuator to open the aperture cover. Alternatively, the opening motion of the actuator may cause the locking mechanism to disengage automatically. The provision of a locking mechanism in the housing assists in securing the housing and preventing or deterring theft of the site scanning device.

The housing may comprise a roof. The roof may be configured to shield the body and the aperture from rain and/or direct sun light.

The aperture may comprise glass.

The aperture cover may comprise a material for withstanding the impact of high velocity shrapnel. The aperture cover material may be a mild steel.

The housing may further comprise a proximity sensor configured to communicate with the controller. The controller may be configured to command the actuator to close the aperture cover if the proximity sensor is triggered. The proximity sensor may be configured to be triggered by a moving object or an object that is a different temperature to the ambient environment. The proximity sensor may be one or more of a passive infrared sensor, an electronic camera or a trip wire. The proximity sensor enables the controller to secure the housing if an animate object, such as a potential thief is detected nearby.

In accordance with a further aspect of the invention there is provided a method for operating a site scanning device and housing, the method comprising:
commanding an actuator of the housing to open an aperture in a body of the housing; and
initiating a scan using the site scanning device.

The method may further comprise determining whether the aperture cover is open. The method may further comprise commanding the site scanning device to cease scanning the site. The method may further comprise determining that the site scanning device has ceased scanning the site. The method may further comprise commanding the site scanning device to initiate a scan only if it has been determined that the aperture cover is open.

The method may further comprise commanding the actuator to close the aperture. The method may perform the step of commanding the actuator to close the aperture only if it has determined that the site scanning device has ceased scanning the site.

In accordance with a further aspect of the invention there is provided a computer program configured to perform the method for operating the controller.

In accordance with a further aspect of the invention there is provided a method of installing a site scanning device and housing, the method comprising providing a site scanning device within the housing.

There is also disclosed a housing for a site scanning device, the housing comprising:
an aperture;
an aperture cover with an open and a closed position;
an actuator configured to move the aperture cover between the open and closed position.

Embodiments of the present invention will now be described by way of example and with reference to the accompanying drawings in which:

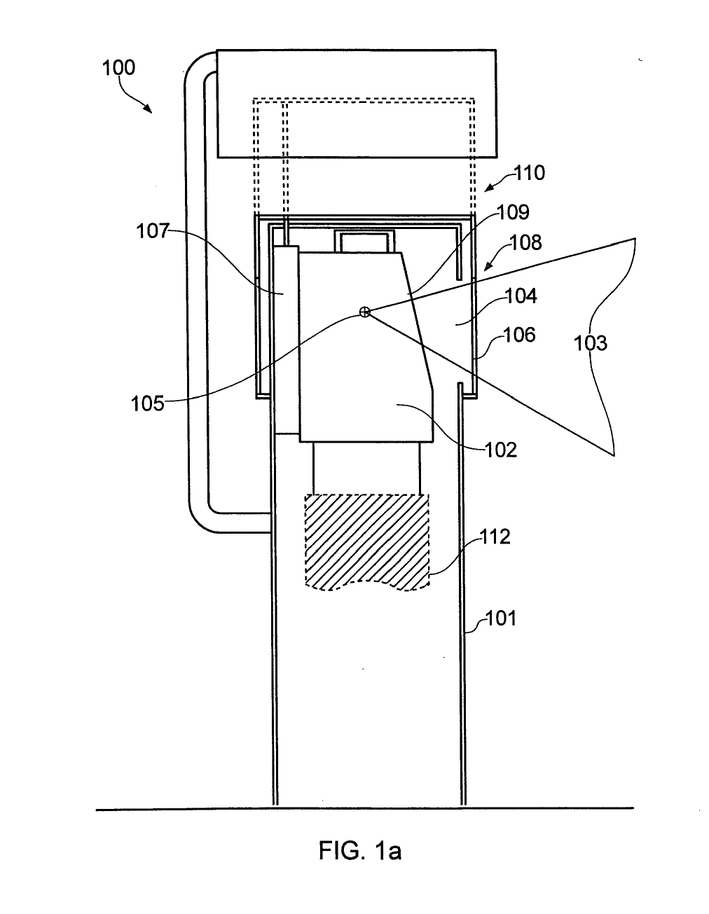

FIG. 1a shows a schematic cross section of a side view of a housing;

FIG. 1b shows a schematic cross section of a front view of the housing;

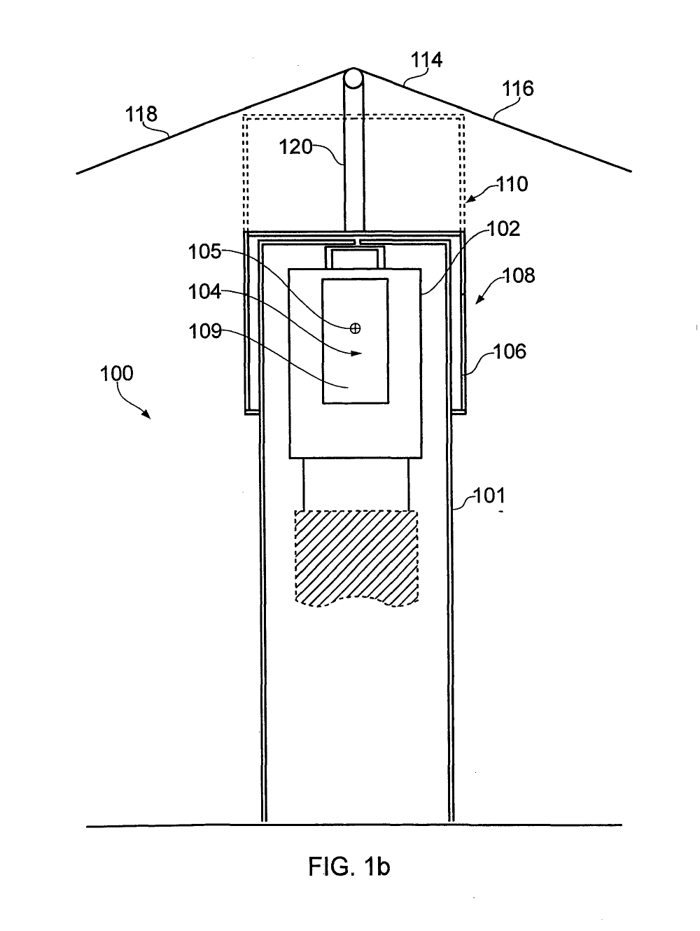

FIG. 2a shows an isometric schematic of a housing with a closed slidable aperture cover;

FIG. 2b shows an isometric schematic of the housing with an open aperture cover;

FIG. 2c shows a side schematic of the housing with a closed aperture cover;

FIG. 2d shows a side schematic of the housing with an open aperture cover;

FIG. 2e shows a front schematic of the housing with a closed aperture cover;

FIG. 2f shows a front schematic of the housing with an open aperture cover;

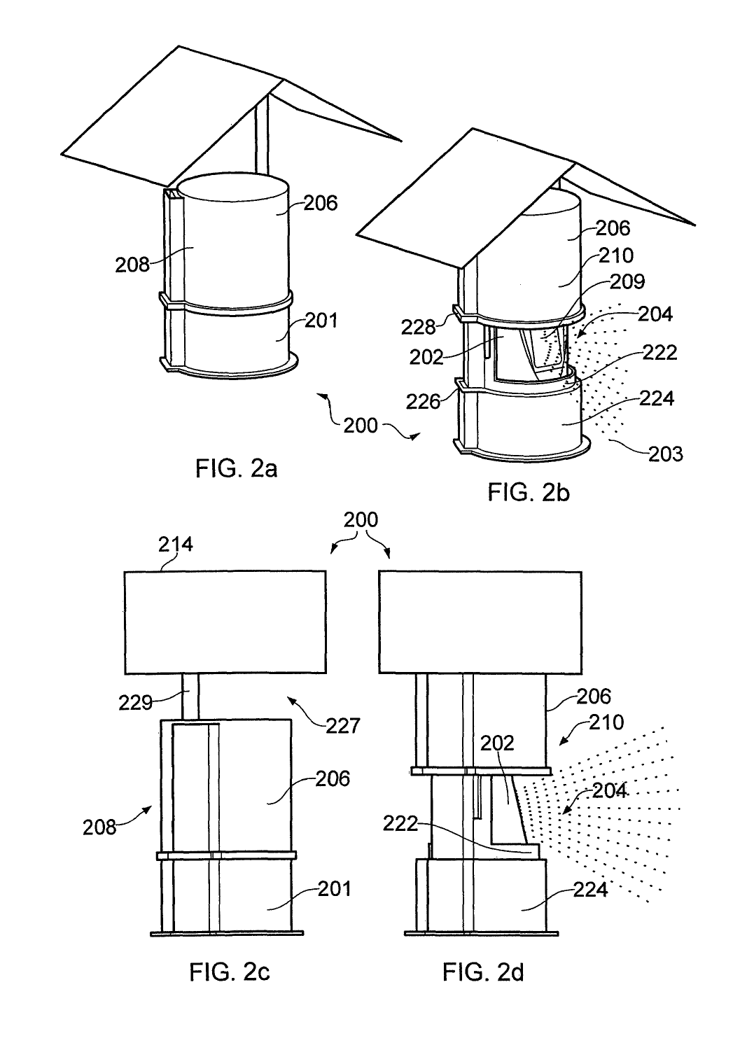

FIG. 3a shows a housing having a closed rotationally operated aperture cover;

FIG. 3b shows the housing having an open rotationally operated aperture cover;

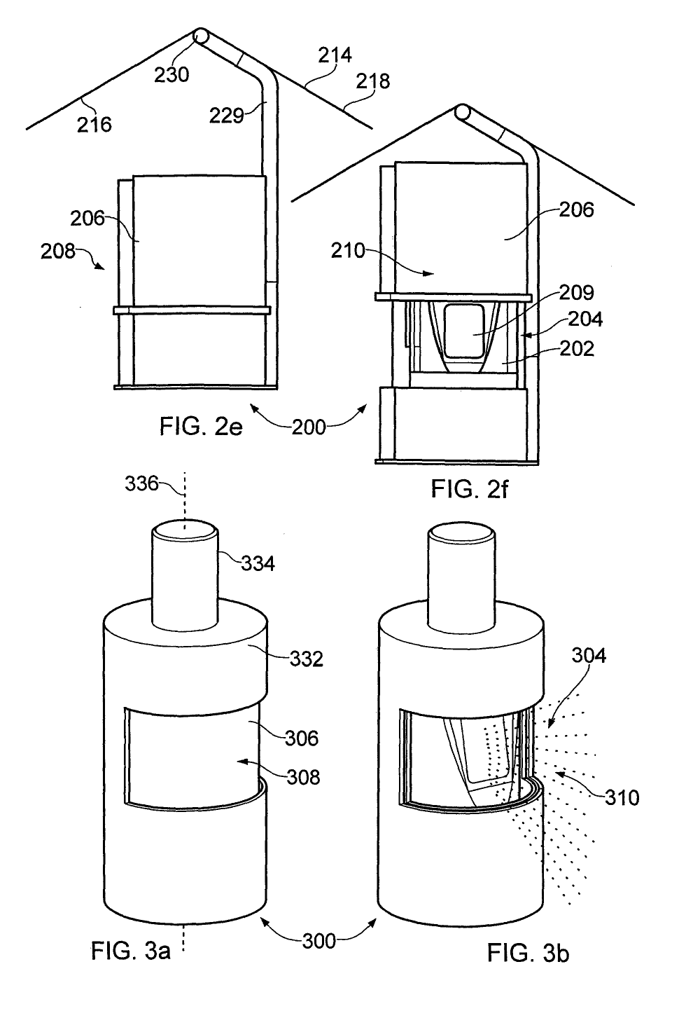

FIG. 4a shows a housing having an closed slidable aperture cover;

FIG. 4b shows the housing having an open slidable aperture cover;

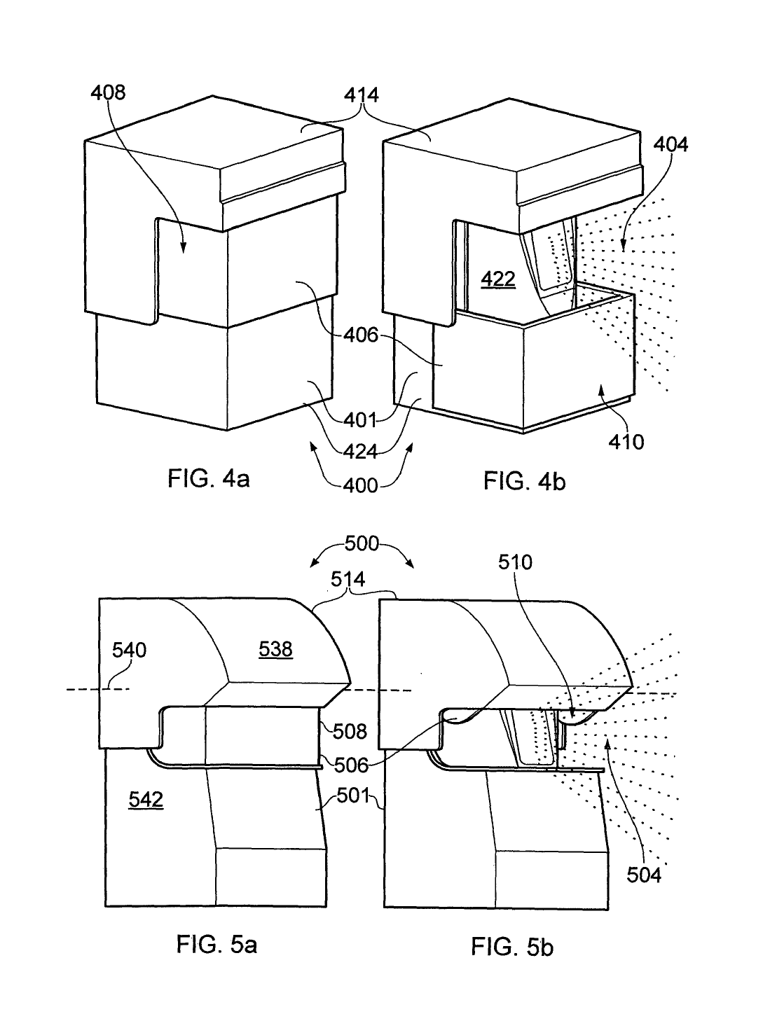

FIG. 5a shows a housing having a closed hinge-operated aperture cover;

FIG. 5b shows the housing having an open hinge-operated aperture cover; and

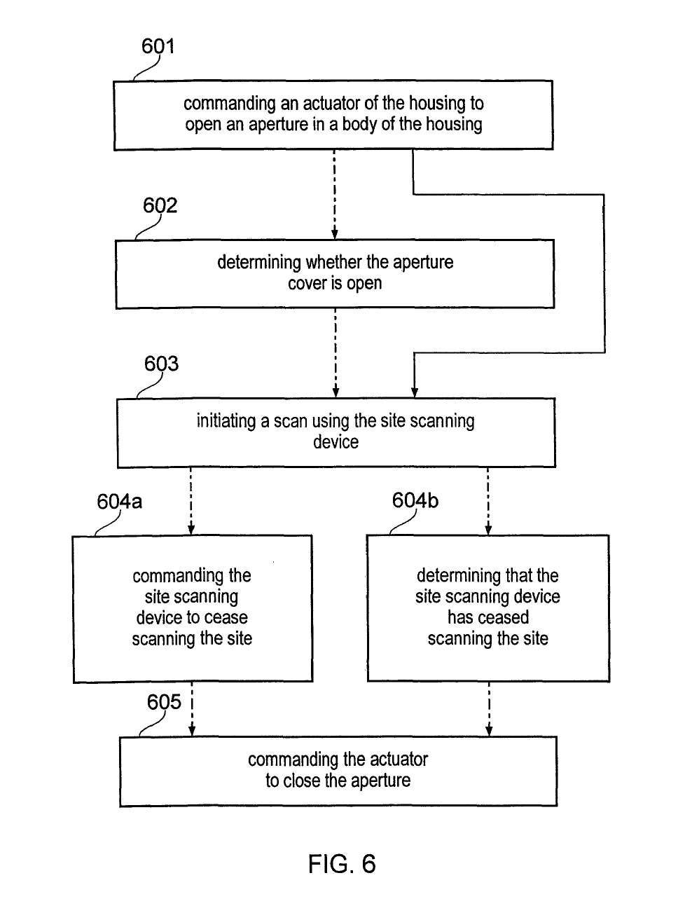

FIG. 6 illustrates a method for operating a site scanning device and housing.

FIGS. 1 to 5 relate to various structural embodiments of housings. Corresponding reference numerals are used to label similar features within the different FIGS. 1 to 5. Some embodiments of the housing may provide a secure housing for the site scanning device that help to protect it against theft or damage. The housing also comprises a controller that may allow for more efficient or convenient operation of the housing and/or the site scanning device. FIG. 6 describes a method that may be performed by a controller of the housing.

FIG. 1 illustrates a housing 100 that has a body 101. A site scanning device 102 is situated within the body 101 of the housing 100.

FIG. 1a illustrates a schematic cross section of a side view of the housing 100 that is perpendicular to a plane normal to the centre of a field of view of a laser 105 of the site scanning device 102. A cross section 103 (when in use) of the field of view of the laser 105 is also shown.

The housing 100 comprises the body 101, an aperture 104, an aperture cover 106, an actuator 107 and a controller. It will be appreciated that the housing may also be considered to comprise the site scanning device 102.

The site scanning device 102 is configured to scan a site, such as a quarry, with a beam of laser light and to observe reflections of that light. The site scanning device 102 may be considered to be a laser mapping device, such as a terrestrial site scanner. A terrestrial site scanner is an example of a static 3D laser scanner that can be mounted on a fixed tripod or pillar. Using the observations of the reflected light, a three dimensional representation of a portion of the site can be provided.

The site scanning device 102 also has a scan beam window 109 situated on its front. The scan beam window 109 acts as an optical input or output of the site scanning device 102.

The aperture 104 is a region between the scan beam window 109 of the site scanning device 102 and an exterior of the housing 100. The aperture 104 is provided by an opening, or void, in a portion of the body 101 of the housing 100. Alternatively, the aperture 104 may comprise a screen in the body 101 of the housing 100. The screen can comprise a material such as glass, or another material that has suitable optical and material properties, such as Perspex. The screen must have suitable properties to allow the efficient transmission of a beam of light emitted from the site scanning device 102 and any reflected light scattered by the site. The screen may be required to meet a quality specification that dictates the proportion of light that is reflected for some applications.

The aperture cover 106 has a closed position 108 and an open position 110. The aperture cover 106 is shown in the closed position 108 in FIG. 1a. The open position 110 of the aperture cover 106 is illustrated by dashed lines. The aperture cover 108 is configured to obscure, or block, the aperture 106 when the aperture cover 108 is in the closed position 108.

The actuator 107 is configured to move the aperture cover 106 between the open position 110 and the closed position 108. In the example illustrated in FIGS. 1a and 1b, the actuator 107 is a linear actuator that is configured to lift the aperture cover 106 from the closed position 108 to the open position 110. The actuator is automatic, in that it works independently of direct manual control. The linear actuator may be provided by a solenoid or a hydraulic or pneumatic piston. Once the aperture cover 106 has been lifted into the open position 110, a latch may be used to hold the aperture cover 106 in place. Alternatively, the actuator 107 may maintain the open position 110 of the aperture cover 106.

In the embodiment shown, the controller can be provided by software within the site scanning device 102. Alternatively, the features of the controller could be provided by additional hardware. The additional hardware can be provided either within the body 101 of the housing 100 or spatially remote from, but still comprised by, the housing 100.

The controller is configured to transmit a signal a command to the actuator 107. The signal comprises a command to open the aperture cover 106. The controller is also configured to transmit a signal to the site scanning device 102. The signal comprises a command to initiate a scan. Additional method steps that may be performed by the controller are discussed in further detail below with reference to FIG. 6.

The body 101 of the housing 100 also comprises a support portion 112 on which the site scanning device 102 is positioned. The support portion 112 could also be provided by a shelf or ledge or by a block of material.

FIG. 1b illustrates a front view of the housing 100 of FIG. 1a. The front view is normal to the centre of the field of view of the laser 105 of the site scanning device 102. The front view intersects a plane of the scan beam window 109 of the site scanning device 102.

The housing 100 also comprises a roof 114. The roof 114 comprises a first sloping portion 116 and a second sloping portion 118, and is supported by a support member 120.

The first and second sloping portions 116, 118 slope away from one another. The sloping nature of the roof allows for the drainage of rain water from the roof. The first and second sloping portions 116, 118 laterally extend beyond the body 101 of the housing. The lateral extension of the first and second sloping portions 116, 118 provides a roof 114 that is configured to prevent direct sunlight from entering the body 101 of the housing 100 through the aperture 104. That is, the roof 114 may provide a sun shield. The lateral extension also helps to prevents gusts of wind from driving rain into the body 101 of the housing 100 through the aperture 104 in embodiments where the aperture 104 is an opening, or void. The roof 114 and the body 101 may be made from a water-proof and water-resistant material, such as stainless, galvanized steel or PVC.

The support member 120 extends in a vertical direction and elevates the first and second sloping portions 116, 118 to a height sufficient that they do not interfere with the travel of the aperture cover 106 between the open position 110 and the closed position 108. Alternatively, the roof 114 may be connected to the top of the aperture cover 106. In that case, the support member 120 may not be required.

FIG. 2 illustrates a number of other different views of another embodiment of the housing 200. FIG. 2a shows an isometric view of the housing 200 where the aperture cover 206 is in the closed position 208.

In this embodiment, the body 201 of the housing 200 comprises a generally cylindrical portion. The aperture cover 206 of the housing 200 also comprises a generally cylindrical portion. The cylindrical portions shown are circular-based cylindrical portions, although they need not be circular-based. The body 201 and the aperture cover 206 have a common axis. The body 201 and the aperture cover 206 also have a rectangular protrusion in their cross section that extends out of the circular base of the cylinder. The rectangular portion may be used to house the actuator.

Alternatively, the body 201 or aperture cover 206 of the housing 200 could be provided by a hollow prism. It will further be appreciated that the body 201 or aperture cover 206 of the housing 200 need not be cylindrical or prismatic.

FIG. 2b shows an isometric view of the housing 200 where the aperture cover 206 is in the open position 210. The scan beam window 209 of the site scanning device 202 and the aperture 204 are exposed when the aperture cover 206 is in the open position 210. Dotted lines illustrating possible beam emissions trajectories (the outer members of which relate to the field of view 203 of the site scanning device) are also shown in FIG. 2b.

The body 201 and the aperture cover 206 have a sliding relationship that allows the aperture cover 206 to be moved between the open and closed positions 208, 210 by the actuator, along the common axis of the cylinders. The actuator is not visible in FIG. 2 as it is within the body 201 of the housing 200. In this embodiment, the aperture cover 206 and the body 201 have a telescopic relationship. The telescopic relationship results in the extension of the combined body 201 and aperture cover 206 in the open position 210 compared to the closed position 208.

The body 201 of the housing 200 comprises an inner portion 222 and an outer portion 224. The inner portion 222 of the body 201 is enclosed by the aperture cover 210 when the cover is in the closed position 208. The inner portion 222 of the body 201 comprises the aperture 204.

The outer portion 224 has a larger radius than the inner portion 222. The outer portion 224 of the body 201 comprises a seal 226 that extends around a periphery of the outer portion 224. The seal 226 is configured to engage with a peripheral edge 228 of the aperture cover 206 when the aperture cover 206 is in the closed position 208. The seal 226 is configured to provide a barrier against the ingress of dust or rain into the housing 200. The seal 226 may be provided by one or more of a tight fit relationship, interlocking body and aperture cover members or a rubberised seal, for example.

The housing 200 may further comprise a locking mechanism that engages when the actuator engages the aperture cover 206 in the closed position 208. Any suitable locking mechanism could be employed, such as a latch, for example. The controller can be configured to command the locking mechanism to disengage. In some embodiments, the opening motion of the actuator can cause the locking mechanism to disengage. Alternatively, the resistance of the actuator may provide a locking mechanism.

FIG. 2c shows a side view of the housing 200 where the aperture cover 206 is in the closed position 208. In the closed position, an air gap 227 is present between the roof 214 and the top of the aperture cover 206. In this view, a pole 229 that supports the roof 214 is visible. The pole 229 may be coupled to the exterior of the body 201 of the housing 200.

FIG. 2d shows a side view of the housing 200 where the aperture cover 206 is in the open position 210. In FIG. 2d it can be seen that the outer portion 224 is broadly cylindrical, but that the inner portion 222 is not cylindrical. The aperture 204 can be considered to be an opening in the surface of the inner portion 222. The field of view 203 of a laser scanning device 202 provided within the housing 200 is illustrated in FIG. 2d.

FIG. 2e shows a front view of the housing 200 where the aperture cover 206 is in the closed position 210. The pole 229 is connected to the roof 214 by a connecting member 230 at a position between the first and second sloping members 216, 218. The connecting member 230 may be provided as a weld or by a suitable securing mechanism such as a nut and a bolt through the roof 214.

FIG. 2f shows a front view of the housing 200 where the aperture cover 206 is in the open position 208. The scan beam window 209 of the site scanning device 202 and the aperture 204 are exposed.

FIGS. 3 to 5 illustrate alternative housing geometries. Similar features between the various designs will not be discussed in further detail except where necessary for further understanding.

FIG. 3 shows a housing 300 having a rotationally operated aperture cover 306. The aperture cover 306 is illustrated in a closed position 308 in FIG. 3a and in an open position 310 in FIG. 3b.

The body 301 of the housing has a major cylindrical portion 332 and a minor cylindrical portion 334. The minor and major cylindrical portions 332, 334 have a circular base, or cross section. The aperture cover 306 comprises a semi-cylinder with a semicircular cross section. The minor and major cylindrical portions 332, 334 and the aperture cover 306 have a common axis 336 of rotation, perpendicular to their respective cross sections. The minor and major cylindrical portions 332, 334 and the aperture cover 306 have a fixed positional relationship. The aperture cover 306 can rotate around the common axis 336 so as to move between the open and closed positions 310, 308 within the body 301 of the housing 300. A motor capable of exerting torque about the axis 336 can be employed as an actuator to effect movement of the aperture cover 306 between the open and closed positions 310, 308. Suitable gearing may also be provided between an output of the motor and the aperture cover 306. The motor may be housed in the minor cylindrical portion 334.

A roof may be mounted on the minor cylindrical portion 334, although none is shown in FIG. 3.

FIG. 4 shows a housing 400 having a slidable aperture cover 406. The aperture cover 406 is illustrated in a closed position 408 in FIG. 4a and in an open position 410 in FIG. 4b.

The slidable aperture cover 406 is configured to slide in a linear motion between the open and closed positions 410, 408. The actuator in this embodiment may, therefore, be a linear actuator. In the closed position 408, the outer portion 424 of the body 401, roof 414 and aperture cover 406 of the housing 400 are visible. In the open position 410, the inner portion 422 of the body is also visible 401.

The roof 414 and the body 401 are in a fixed physical relationship. The roof 414 in this embodiment comprises a portion of a cuboid that overlies a broadly cuboidal outer portion 424 of the body 401. By the roof 414 overlying the body 401, it is meant that the roof 414 has a cross section that extends beyond that of the body 401. The difference in cross section enables the roof to provide rain and sun shielding to the aperture 404 of the body 401.

The aperture cover 406 is also configured to overlie the outer portion 424 of the body 401 and underlie the roof 414. The aperture cover 406 extends around three faces of the outer portion 424 of the cubodial body 401. Alternatively, the aperture cover 406 could underlie the outer portion 424 of the body 401 and so be within the outer portion 424 when in the open position 410.

FIG. 5 shows a housing 500 having hinge-operated aperture cover 506. The aperture cover 506 is illustrated in a closed position 508 in FIG. 5a and in an open position 510 in FIG. 5b.

The roof 514 in this example is similar to that of the housing 400 of FIG. 4, except that it has a curved surface between its top face and front face 538 so as to receive the hinge-operated aperture cover 506. The front face 538 may be considered as the face on the side of the body 501 that comprises the aperture 504. The hinge of the aperture cover has an axis 540 that passes through sides 542 of the body 401 and/or roof that are perpendicular to the front face 538. The aperture cover 506 may pivot about the axis 540 between the open and closed positions 510, 508. A rotational or linear actuator may be employed to pivot the aperture cover 506.

FIG. 6 illustrates a method for operating a site scanning device and housing. The method comprises the step 601 of commanding an actuator of the housing to open an aperture in a body of the housing. The method may, optionally, further comprise the step 602 of determining whether the aperture cover is open. The method further comprises the step 603 initiating a scan using the site scanning device. In some embodiments, this step 603 is only performed if it has been determined that the aperture cover is open.

The method may optionally further comprise the step 604a of commanding the site scanning device to cease scanning the site. Or alternatively, the method may optionally further comprise the step 604b of determining that the site scanning device has ceased scanning. After completing either of these steps 604a, 604b of commanding or determining, the method may comprise the step of commanding the actuator to close the aperture 605.

It will be appreciated that the controller of the housing may perform the method illustrated in FIG. 6. The commands issued by the controller may be comprised by signals transmitted by the controller. The controller may be internal or external to the body of the housing.

The step 603 of initiating a scan using the site scanning device may be performed by the controller transmitting a signal to the site scanning device. The transmitted signal comprises a command to initiate a scan. Alternatively, the site scanning device may perform the step 603 of initiating a scan itself. In this case, the site scanning device may transmit a signal to the controller. The signal received by the controller comprises an indication that the scan has been or will be initiated. The controller then commands the actuator to open the aperture cover in response to the received signal.

The controller can be provided as a simple electronic or electrical switch. In this case the step 601 of commanding the actuator and the step 603 of initiating a scan may be performed substantially simultaneously.

Alternatively, the controller may be configured to control the housing and the site scanning device automatically. The controller may operate automatically by operating a timer or performing conditional logic to make decisions. The controller may be provided as hardware or software, or as a combination of the two. The command can comprise an electrical or electronic signal.

The controller can be configured to determine whether the aperture cover is in the open position, as in step 602. Suitable hardware or software routines could be provided within the controller to provide a predetermined delay period between the step 601 of commanding the actuator and the step 603 initiating a scan. The predetermined delay period corresponds to the time that the actuator is expected to take to open the aperture cover. The controller can inspect a delay timer to assess whether the predetermined delay period has elapsed. In this embodiment, the controller activates the delay timer simultaneously with commanding the aperture cover to open.

Alternatively, the controller can be configured to sense whether the aperture cover is in the open position by using a microswitch, for example, to perform the determination of step 602.

As a further alternative, the controller may monitor data provided by the site scanning device, such as scanning data for example, to perform the determination of step 602.

The controller may activate a predetermined scan timer simultaneously with commanding the site scanning device to initiate a scan. The controller may perform the determination of method step 604b by inspecting the predetermined scan timer to determine whether a predetermined scan period has elapsed. The predetermined scan period may correspond with the expected duration of a scan.

In some embodiments, the housing may also comprise a proximity sensor, such as a passive infrared (PIR) sensor, configured to communicate with the controller. The controller may be configured to command the closure of the aperture cover if the proximity sensor detects the presence of a nearby moving object. The provision of such a feature can prevent theft of the site scanning device during use by isolating it within the housing.

1. A terrestrial laser scanner housing comprising:
an aperture;
an aperture cover having an open position and a closed position;
an actuator configured to move the aperture cover between the open position and the closed position; and
a controller configured to control the actuator and to interface with a terrestrial laser scanner.

2. The housing of claim 1, wherein the controller is further configured to receive a signal from the terrestrial laser scanner and control the actuator in response to the received signal.

3. The housing of claim 1, wherein the controller is further configured to control terrestrial laser scanner.

4. The housing of claim 3, wherein the controller is further configured to transmit a signal to the terrestrial laser scanner in order to control it.

5. The housing of claim 1, wherein the controller is further configured to synchronise timing of actuator operation and terrestrial laser scanner operation.

6. The housing of claim 1, wherein the controller is configured to command the actuator and the terrestrial laser scanner automatically.

7. The housing of claim 1, wherein the controller is configured to:
determine whether the aperture cover is in the open position; and
command the terrestrial laser scanner to initiate a scan if the aperture cover is in the open position.

8. The housing of claim 1, wherein the controller is configured to determine when the terrestrial laser scanner has completed a scan and to command the actuator to close the aperture cover.

9. The housing of claim 1, wherein the controller is further configured to command the terrestrial laser scanner to cease scanning and to command the actuator to close the aperture cover.

10. The housing of claim 1, wherein the housing has a body that comprises the aperture, and a portion of the body that comprises the aperture is obscured by the aperture cover when the aperture cover is in the closed position.

11. The housing of claim 10, wherein the aperture cover comprises a cylinder and the housing comprises a cylindrical body.

12. The housing of claim 10, wherein the aperture cover comprises a prism and the housing has a prismatic body.

13. The housing of claim 10, wherein the aperture cover and the body have a sliding relationship enabling the aperture cover to move between the open position and the closed position.

14. The housing of claim 13, wherein the sliding relationship is a linear or rotational sliding relationship.

15. The housing of claim 14, wherein the aperture cover and the body have a common axis about which the aperture cover is configured to rotate.

16. The housing of claim 14, wherein the rotational sliding relationship is provided by a hinge between the aperture cover and the body.

17. The housing of claim 10, further comprising a seal configured to engage the aperture cover and the body.

18. The housing of claim 1, further comprising a locking mechanism, the locking mechanism configured to engage lock the aperture cover in the closed position.

19. The housing of claim 1, further comprising a roof configured to shield the body and the aperture from rain and direct sun light.

20. The housing of claim 1, further comprising a terrestrial laser scanner disposed within the housing.

21. The housing of claim 1, wherein the terrestrial laser scanner comprises the controller.

22. The housing of claim 1, wherein the controller is outside the body of the housing.

23. (canceled)

24. The housing of claim 1, further comprising a proximity sensor configured to communicate with the controller, wherein the controller is further configured to command the actuator to close the aperture cover if the proximity sensor is triggered.

25. A method for operating the terrestrial laser scanner and the terrestrial laser scanner housing of claim 1, the method comprising:
commanding an actuator of the housing to open an aperture in a body of the housing; and
initiating a scan using the terrestrial laser scanner.

26. The method of claim 25, further comprising:
determining whether the aperture cover is open; and
initiating a scan if the aperture cover is open.

27. The method of claim 25, further comprising:
commanding the terrestrial laser scanner to cease scanning the site; and
commanding the actuator to close the aperture.

28. The method of any of claim 25, further comprising:
determining that the terrestrial laser scanner has ceased scanning the site; and
commanding the actuator to close the aperture.

29. (canceled)

30. (canceled)

31. (canceled)

32. (canceled)
